(19) United States
(12) Patent Application Publication
(10) Pub. No.: US 2019/0160710 A1
(43) Pub. Date: May 30, 2019

(54) Memorial object for preserving cremains and methods to produce

(71) Applicants: Christina Allison, Spiceland, IN (US); Brenda Brown, Spiceland, IN (US)

(72) Inventors: Christina Allison, Spiceland, IN (US); Brenda Brown, Spiceland, IN (US)

(21) Appl. No.: 16/313,630

(22) PCT Filed: Aug. 14, 2017
(86) PCT No.: PCT/US17/46750

§ 371 Date: Dec. 27, 2018

Related U.S. Application Data
(60) Provisional application No. 62/374,900, filed on Aug. 14, 2016.

(51) Int. Cl. B29C 33/38; B29C 39/00; B28B 7/34; B28B 1/14; A61G 17/08

(52) U.S. Cl. CPC B29C 33/3857; B29C 39/003; B28B 7/346; B29K 2511/06; A61G 17/08; B29C 2033/3871; B28B 1/14

(57) ABSTRACT

This device is a memorial product manufactured with cremation remains encased in various non-glass materials. A is the making of a special impression molding device from an original form of a person, pet or special object, alive or deceased, and processing this form as a memorial and a vessel made from cremation ashes. The final restoration can be accurate and well adapted from the initial impression. Then a cementitious or plaster of Paris mix is used for the purposes of making the memorial product from the impressions. A ratio of water to cementitious material and other additives are suitable. The mix flows well into the pits, fissures and undercuts. It shows impeccable details. If desired, a finish seal, paint, electro-plate, or metal leaf can be utilized as a finish.

### CROSS-REFERENCE TO RELATED APPLICATIONS

This application claims the benefit of the PCT Filing PCT/US17/46750 on Aug. 14, 2017, by Christina Allison et al and entitled “Memorial object for preserving cremains and methods to produce”. This application claims the original benefit of the U.S. Provisional Patent Application Ser. No. 62/374,900 filed Aug. 14, 2016, by Christina Allison et al and entitled “Memorial object for preserving cremains and methods to produce”.

### FIELD OF INVENTION

This invention relates a memorial products, and more particularly to a memorial product with cremation remains encased in various non-glass materials. It encompasses methods of manufacturing a memorial product in this disclosure and application. The instant invention describes a method to convert ashes or other remains of the cremation (such as bone fragments) into solid, durable objects and/or ornamental products such as composite, coloring and paints. This invention relates to a technique for preserving the remains of a deceased individual. More specifically, the invention relates to a method for preserving cremated ash remains of a deceased individual by consolidating the ashes into a cementitious or resin that solidifies within a mold or similar container to create a permanent, solid sculpture-like memorial. This invention encourages the use of an apparatus for mixing a cremains powder with a liquid, and in particular, to a mixing jar for quickly mixing components of a fast-setting, flowable molding compound. This invention relates to a device in the form of a kit, a method of making the kit, and a method of use of the kit for the fabrication of a living or deceased body to produce a memorial object. The present invention relates generally to memorials for alive or deceased persons and animals, and particularly to a memorial with cremains or future cremains that provide a small household memorial or shrine encapsulating the cremains therein, and to a method of making such a memorial or shrine. This invention is in the field of methods of casting, and in particular kits and methods of their use for making glass castings of impressions of body parts and the like for use as memorabilia. Further this invention relates in general to memorial objects. More particularly, the invention relates to memorial objects cast from a cementitious material and incorporating cremation ashes from a loved one or a pet in a permanent medium as a statue, ornament, gemstone or the like. The present invention relates to the memorialization of cremated remains, and in particular, to a presentation system and method of preparation thereof for the display of cremated remains. Further, the system teaches a particular methodology for the artistic application of cremated remains upon a substrate for presentation.

### FEDERALLY SPONSORED RESEARCH

None.

### SEQUENCE LISTING OR PROGRAM

None.

### BACKGROUND—FIELD OF INVENTION AND PRIOR ART

This is background as to Memorial objects for preserving cremains device and methods to produce. In recent years, cremation has become an increasingly common option for many people. Cremation is often less expensive than traditional burial and may be considered more environmentally friendly as resources are not expended on caskets and vaults, and land is not consumed for use as a cemetery. When the body of the deceased person or animal is cremated, there remains a portion of ash commonly known as cremation remains or cremains. The cremation remains often include inorganic matter that was not consumed during the cremation process. Additionally fragments of bones may remain after the cremation, and those fragments may be crushed or ground and mixed with the ash and other materials that survive the cremation process.

In the past, it has been customary for cremation remains to be provided to the family of the deceased in an urn. As an average human may produce several pounds of cremation remains, typically urns have consisted of a large container with a lid in which the cremation remains are stored. In some urns, the cremation remains are enclosed in a plastic bag. Most urns are readily identifiable as an urn and may be associated with death and morbidity. As such, after an initial grieving period, urns tend not to be displayed prominently. In addition, if the urn is upset the cremation remains may be spilled. As the cremation remains include many fine particles and ash, it may not be possible to return the cremation remains to the urn once spilled. It is also common for cremation remains to be scattered in a location or manner requested by the deceased. Once the remains are scattered in this fashion, the urn is unlikely to be reused and may be stored until discarded.

In view of the limitations of currently available products, there exists a need for a memorial product that allows cremation remains to be protected and displayed. Such a product may create additional opportunities to remember the deceased allowing friends and family members to remember the deceased without the morbid association of urns and other funeral products. A memorial product is presently disclosed that includes a cementitious or resin based material with the cremains made from a mold of the deceased body parts.

Cremation has been used worldwide for many centuries by many societies. The method has been chosen over burial either because of religious reasons or the convenience of reducing a body mass into ashes. The ashes can last indefinitely, primarily because ashes contain inorganic matters, which will never spoil. Traditionally, the method of cremation has been practiced in eastern societies such as among Hindus. The cremation practice is becoming more popular among western countries including the United States in the recent years, and cremation currently accounts for twenty four (24) percent of all final dispositions in the United States. Cremation is also being used with increasing numbers for deceased pets too.

### Prior Art—

A novelty search reveals no prior art anticipating or rendering as obvious this new, unique Memorial object 30 for preserving cremains device and methods 80 to produce memorial objects. A U.S. Pat. No. 8,627,555 entitled Memorial Product Including Cremation Remains was issued to Kennedy in 2014. Another US Patent Application 2013/0206626 entitled Method and Device for Fabricating a Patient-Specific Implant was submitted by Schindel in 2013. Another A US Patent Application 2010/0199476 entitled Memorial with Cremains was submitted by Cummings et al. in 2010. A further A US Patent Application US 2010/0148393 entitled Casting Kit and Method of Using Same was submitted by Carrillo in 2010. In 2009 a patent application US 2009/0077779 entitled Memorial Objects Incorporating Cremation Ash was submitted by Zimmerman et al. A U.S. Pat. No. 6,615,463 by Hojaji entitled Methods to Solidify Creamation Ash was issued in 2003. A US Patent Application 2003/0038397 and entitled Apparatus and Method for Molding an Animal Body Part was submitted by MacAllister et al. Still another US Patent Application 2002/0025392 called Permanent Memorial Created from Cremation Remains and Process for Making the Same was entered by Yardley et al. A U.S. Pat. No. 6,200,507 entitled Method of Making a Memorial for Preservation of Remains of Deceased Individual issued to Dennis in 2001.

A U.S. Pat. No. 6,086,807 entitled Mold for Cast Piece went to Wilson in 2000. Further a U.S. Pat. No. 6,042,557 was entitled Orthopedic Splint and Method Of Making Same and was issued to Ferguson et al. in 2000. A U.S. Pat. No. 5,364,580 named Bold Part Mold System issued to Prent in 1994. Another U.S. Pat. No. 5,057,606 entitled Form-In-Place Polysaccharide Gels went to Garbe in 1991. An earlier U.S. Pat. No. 4,941,212 entitled Method of Making a Face Applying the Face Mask to the Head issued to Liff back in 1990. Further, a U.S. Pat. No. 4,735,754 entitled Method for Fabricating Artificial Body Parts was issued to Buckner in 1988. U.S. Pat. No. 4,381,947 went to Pellico in 1983 and was known as Settable Alginate Compositions. An early U.S. Pat. No. 2,816,843 entitled Impression Composition was issued to Erickson in 1957. As far as known, there are no Memorial object for preserving cremains device and methods to produce or the like. It is believed that this product is unique in its design and technologies.

### Problem Solved—

The need exists with human or pet remains for a method to convert remains to a solid, durable object that not only has spiritual and moral values, but it is appealing to the eyes and can have also functional and decorative properties. More and more people are specifying in their wills that they wish to have their remains cremated, rather than requesting burial after they die. Cremation serves as a response to all of the above problems, but then introduces the problem of storage of the cremated ashes or cremains of the deceased. It is generally considered customary for family or descendents to retain the cremains in an urn or the like provided by the crematorium that performed the process. While a crematorium may provide a selection of a number of different urn styles and configurations, they all still have the general configuration of an urn and are not generally particularly artistic. The present inventors are aware of various attempts that have been made in the past to preserve cremains. Casting is a well-known manufacturing process whereby a material in liquid form is poured into a mold, the mold representing the topology and volume of an object to be replicated. Molds are generally fashioned from materials that retain their form in the presence of the casting material, for example metal, or packed sand. The casting material can comprise, for example, plaster, plastics, concrete, resins, metals, or glass, and combinations thereof. Casting is especially useful as a method of replicating complex three-dimensional shapes, which would otherwise have to be produced by uneconomical means, such as hand carving. Furthermore, casting is also a useful and economic way to produce items that are not easily produce by usual methods of machining. Many items have such complex surface topologies such that casting is the only practical method with which to reproduce such shapes.

If the remains of a deceased person are cremated and the ashes usually placed in an urn for delivery to the survivors of the deceased. Approximately 7 to 10 pounds of cremation residue are produced upon cremation of the average adult. A memorial in the form of a casting with the cremains provides significant benefits and advantages to the offspring and beneficiaries of the deceased.

There remains a need for a memorial object that incorporates the cremation ashes of a loved one, or a pet, wherein the memorial is relatively inexpensive and simple to make, is durable for indoor or outdoor use, may be kept with the survivor or survivors of the deceased, and which may be given any desired size, shape, theme or color. More specifically, there is need for a memorial object made from cast or molded concrete having cremation ash incorporated therein and preferably one or more additives to obtain a desired surface finish and to improve flowability, strength, and durability.

While none of the prior art was found teaching the method of the present invention, the Memorial object for preserving cremains device and methods to produce provides a unique, un-obvious and novel manner and devices to preserve a deceased's remains.

### SUMMARY OF THE INVENTION

This invention is a Memorial object for preserving cremains device and methods to produce. Taught here are the ways a deceased remains may be processed and memorialized. This is the making of a special impression device and processing this device as a memorial and a vessel made from cremation ashes. The final restoration can only be as accurate and well adapted as the initial impression. the concrete mix used for the purposes of making impressions and the ratio of water to cement and additives are suitable for this project due to the research and development processes. The mix flows well into the pits, fissures and undercuts. It shows impeccable details.

The preferred embodiment of a method to produce the Memorial object for preserving cremains is comprising the following steps: (a) Selecting a body part of a person and/or an object for the impression; (b) Selecting a vessel/container for the impression; (c) Selecting a humanly safe, fast setting, resilient, and penetrating impression material; comes from group—(1) Deciding an amount of the impression material required alginate/silicone; (2) Obtaining a mixing vessel to mix solid/powder with liquid (if alginate type or equal) or obtain resin and setting material if pliable liquid like silicone base or equal; (3) Mixing impression material right before needed to pre-set with person to a homogeneous smooth mixture; and (4) Placing in receiving container or begin external layer coat (depending on part for impression);—(d) Preparing the person and/or object for the impression—(1) Plastic sheet on surface under person and parts; (2) Cover person at area near body part to immerse or layer/surface apply; and (3) Pre spray/coat body parts if required for impression material (mold release); (e) Coating Submersing the person and/or object layering from a surface the person and/or object art with the humanly safe, fast setting, resilient, and penetrating impression material—(1) Moving the immersed object of body part to remove bubbles, relieve surface tension; use spatula and hands to build up surface coating and (2) Wrapping a surface area with cloth or paper towels to encapsulate; (f) Waiting a set time for the impression material to set to a resilient state; (g) Breaking a seal on immersed part or surface coat and remove a reverse impression; (h) Inspecting the reverse impression for mold surface quality—repeating steps (a) to (g) if necessary for quality; (i) Mixing a cementitious, plastic or composite moldable materials with a cremains from a person; (j) Filling the reverse mold impression with the moldable material and the cremains; (k) Allowing the moldable material and the cremains to solidify and set; (l) Removing from the impression the memorial object of the body part of a person and/or an object; (m) Inspecting the memorial object; (n) Finishing a surface of the memorial object—clear coat, paint, metal leaf or other—(o) Mounting (if desired) and labeling for displaying; and (p) Repeating steps for other molding of memorial objects as desired.

### Objects and Advantages

There are several objects and advantages of the Memorial object for preserving cremains device and methods to produce. There are currently no known memorial devices or methods as shown herein to preserve the cremains of a deceased person.

The Memorial object for preserving cremains device and methods to produce have various advantages and benefits:

| Item | Advantages |
|---|---|
| 1 | Is fast to preserve memorial parts |
| 2 | Utilizes most materials and methods that are available but utilized |
| | in other unlike industries |
| 3 | Provides a more economical than preservation in urns or glass |
| | memorials |
| 4 | Provides impressions that can be used in multiple memorials for |
| | numerous descendants and beneficiaries |
| 5 | Has an ease of mixing the molding materials and manipulation of |
| | the body parts |
| 6 | Requires no elaborate equipment needed |
| 7 | Uses a molding material that is elastic and comes out easily from |
| | undercuts |
| 8 | Utilizes a molding material is very economical to use if bought in |
| | bulk |
| 9 | Provides a final restoration that can be accurate and well adapted to |
| | the initial impression |
| 10 | Uses a molding material is very durable and easy to use |
| 11 | Has a molding material that can be transported with limited space |
| | available |
| 12 | Provides a manner to keep loved ones close |
| 13 | Provides the cremains of the loved ones and are sealed and can be |
| | used as display |
| 14 | Provides a physical presence of the loved ones |
| 15 | Is a tangible way to hold on the loved ones |
| 16 | Is an alternative or cremation remains other than what is available |
| | to the customer such as jewelry or an urn |

Finally, other advantages and additional features of the present Memorial object for preserving cremains device and methods to produce will be more apparent from the accompanying drawings and from the full description of the device. For one skilled in the art of preserving cremains or providing memorials for the deceased, it is readily understood that the features shown in the examples with this product are readily adapted to other types of cremains memorial preservation objects and devices.

### DESCRIPTION OF THE DRAWINGS—FIGURES

The accompanying drawings, which are incorporated in and constitute a part of this specification, illustrate an embodiment of the Memorial object for preserving cremains device and methods to produce that is preferred. The drawings together with the summary description given above and a detailed description given below serve to explain the principles of the Memorial object for preserving cremains device and methods to produce. It is understood, however, that the Memorial object for preserving cremains device and methods to produce is not limited to only the precise arrangements and instrumentalities shown.

FIGS. 1 A through 1 D are sketches of the general memorial object for preserving cremains device and methods to produce.

FIGS. 2 A through 2 H are sketches of the example memorial objects for preserving cremains.

FIG. 3 A through 3 G are sketches of the mixing and preparation of the mold material.

FIGS. 4 A through 4 G are sketches of the remaining steps for the immersion process to produce memorial objects for preserving cremains.

FIGS. 5 A through 5 E are sketches of the initial Steps for the larger process to produce memorial produce memorial objects for preserving cremains.

FIGS. 6 A through 6 E are sketches of additional steps in the larger process to produce memorial objects with cremains.

FIGS. 7 A through 7 F are sketches of the final steps to produce the mold from the larger process and to produce memorial objects with cremains.

FIGS. 8 A and 8 B are sketches of adding jewelry to the mold and 8 C through 8 E show preserving the object or filling the mold.

FIGS. 9 A through 9 E are sketches of removing the mold from the memorial object with cremains.

FIG. 10 is the specific process or method to produce the memorial object with cremains.

FIGS. 11 A through 11 E are sketches of prior art in memorial objects with cremains and molding processes.

### DESCRIPTION OF THE DRAWINGS—REFERENCE NUMERALS

The following list refers to the drawings:

TABLE B
Reference numbers

| Ref # | Description |
|---|---|
| 30 | memorial objects 30 for preserving cremains |
| 31 | folded hands object 31 |
| 32 | closed fist object 32 |
| 33 | clenched hands 33 |
| 34 | praying hands 34 |
| 35 | open hand 35 |
| 36 | foot 36 |
| 38 | finished object 38 with surface finish - paint, clear coat, metal leaf, |
| | powder coat, sealing, electro plating metal, or the like |
| 40 | process of immersing 40 object mold preparation |
| 41 | mold materials 41 alginate, silicone or other humanly safe, fast |
| | setting, resilient, and penetrating to accurately portray details of the |
| | memorial object |
| 42 | adding liquid 42 |
| 43 | mix container 43 |
| 44 | mixing device 44 |
| 45 | mixed molding materials 45 |
| 45A | alternate mold material requires coverage 62 and moisturizing |
| 46 | transfer material means 46 |
| 47 | immersion vessel 47 |
| 48 | mold 48 and object 91 removed from vessel 47 |
| 49 | adding 49 cementitious material 50 |
| 50 | cementitious material 50 such as cement, concrete, plaster of Paris |
| | or durable plastics, composite materials and other suitable materials |
| | for mixing cremains and ash into the parent material. Can be |
| | opaque, transparent, translucent or solid colors. |
| 51 | set/gelled object 51 |
| 55 | base or frame 55 for object 30 |
| 60 | process of layering/surface mold preparation 60 |
| 61 | cover 61 over object 91 |
| 62 | cover fabric or paper/sheet towels 62 |
| 65 | gelled mold 65 |
| 66 | means 66 to trim flash from gelled mold 65 |
| 67 | reverse mold cavity 67 |
| 68 | trimmed 68 reversed mold cavity 67 |
| 69 | comparison step 69 |
| 70 | optional plaster of Paris 70 or equal to add jewelry details 71 |
| 71 | jewelry details of a large ring 71 and the like |
| 72 | removed mold material 72 |
| 73 | protective sheet 73 |
| 74 | object 74 such as a pipe, book, sports memorabilia, special jewelry |
| | and the like |
| 75 | special pet 75 - dog, cat, bird, paw or the like |
| 80 | method of making memorial objects for preserving cremains 80 |
| 90 | operator 90 |
| 91 | person or corpse 91 |
| 92 | specific body part 92 can be alive or dead. If alive, the mold makes |
| | a master replica that can be used when the person dies to mold the |
| | cremains of the deceased |
| 100 | prior Art 100 Patent Application US 2009/0077779 by Zimmerman |
| 101 | prior Art 101 Patent Application US 2010/0199476 by Cummings, |
| | et al. |
| 102 | prior Art 102 U.S. Pat. No. 8,627,555 by Kennedy |
| 103 | prior Art 103 U.S. Pat. No. 6,200,507 by Dennis |
| 104 | prior Art 104 U.S. Pat. No. 6,086,807 by Wilson |

### DETAILED DESCRIPTION OF PREFERRED EMBODIMENT

The present development is a Memorial object for preserving cremains device and methods to produce. This invention relates to a memorial product, and more particularly to a memorial product with cremation remains encased in various non-glass materials. It encompasses methods of manufacturing a memorial product in this disclosure and application. The instant invention describes a method to convert ashes or other remains of the cremation (such as bone fragments) into solid, durable objects and/or ornamental products such as composite, coloring and paints. This invention relates to a technique for preserving the remains of a deceased individual.

The advantages for the Memorial object 30 for preserving cremains device and methods 80 to produce memorial objects are listed above in the introduction. Succinctly the benefits are that the device and method:
A. Is fast to preserve memorial parts
B. Utilizes most materials and methods that are available but utilized in other unlike industries
C. Provides a more economical than preservation in urns or glass memorials
D. Provides impressions that can be used in multiple memorials for numerous descendants and beneficiaries
E. Has an ease of mixing the molding materials and manipulation of the body parts
F. Requires no elaborate equipment needed
G. Uses a molding material that is elastic and comes out easily from undercuts
H. Utilizes a molding material is very economical to use if bought in bulk
I. Provides a final restoration that can be accurate and well adapted to the initial impression
J. Uses a molding material is very durable and easy to use
K. Has a molding material that can be transported with limited space available
L. Provides a manner to keep loved ones close
M. Provides the cremains of the loved ones and are sealed and can be used as display
N. Provides a physical presence of the loved ones
O. Is a tangible way to hold on the loved ones
P. Is an alternative or cremation remains other than what is available to the customer such as jewelry or an urn

The preferred embodiment of a method to produce the Memorial object for preserving cremains is comprising the following steps: (a) Selecting a body part of a person and/or an object for the impression; (b) Selecting a vessel/container for the impression; (c) Selecting a humanly safe, fast setting, resilient, and penetrating impression material; comes from group—(1) Deciding an amount of the impression material required alginate/silicone; (2) Obtaining a mixing vessel to mix solid/powder with liquid (if alginate type or equal) or obtain resin and setting material if pliable liquid like silicone base or equal; (3) Mixing impression material right before needed to pre-set with person to a homogeneous smooth mixture; and (4) Placing in receiving container or begin external layer coat (depending on part for impression);—(d) Preparing the person and/or object for the impression—(1) Plastic sheet on surface under person and parts; (2) Cover person at area near body part to immerse or layer/surface apply; and (3) Pre spray/coat body parts if required for impression material (mold release); (e) Coating Submersing the person and/or object layering from a surface the person and/or object art with the humanly safe, fast setting, resilient, and penetrating impression material—(1) Moving the immersed object of body part to remove bubbles, relieve surface tension; use spatula and hands to build up surface coating and (2) Wrapping a surface area with cloth or paper towels to encapsulate; (f) Waiting a set time for the impression material to set to a resilient state; (g) Breaking a seal on immersed part or surface coat and remove a reverse impression; (h) Inspecting the reverse impression for mold surface quality—repeating steps (a) to (g) if necessary for quality; (i) Mixing a cementitious, plastic or composite moldable materials with a cremains from a person; (j) Filling the reverse mold impression with the moldable material and the cremains; (k) Allowing the moldable material and the cremains to solidify and set; (l) Removing from the impression the memorial object of the body part of a person and/or an object; (m) Inspecting the memorial object; (n) Finishing a surface of the memorial object—clear coat, paint, metal leaf or other—(o) Mounting (if desired) and labeling for displaying; and (p) Repeating steps for other molding of memorial objects as desired.

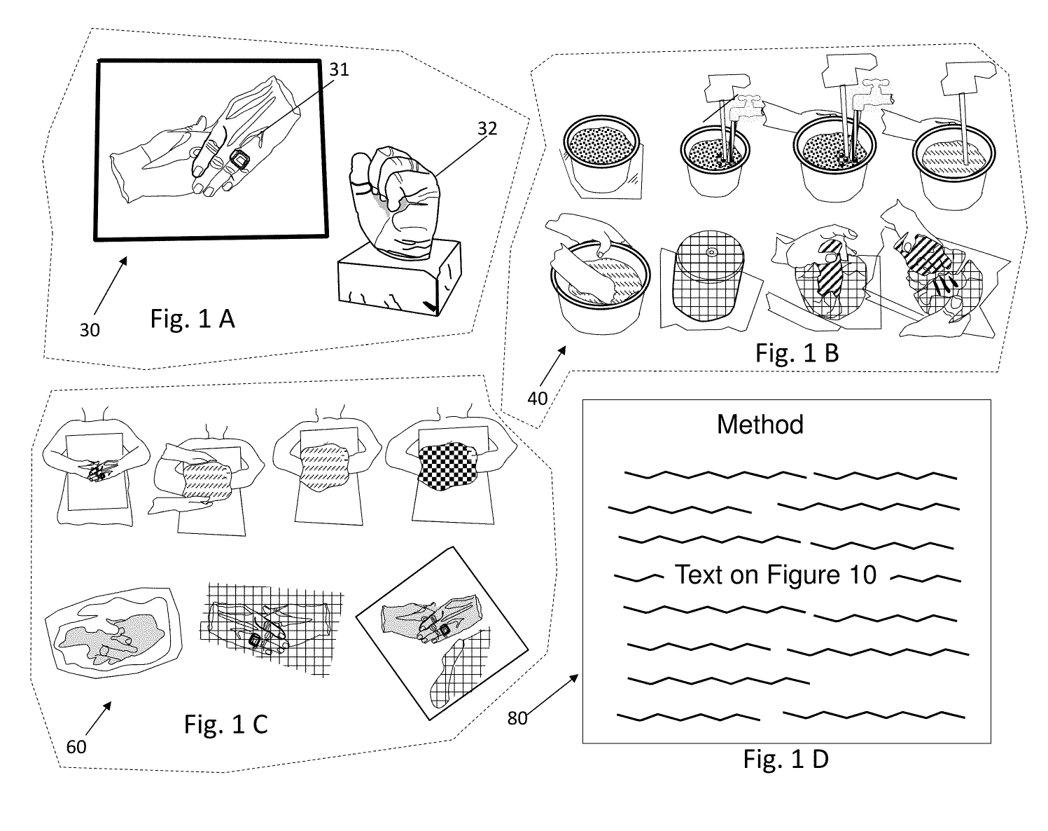

There are shown in FIGS. 1-11 a complete description and operative embodiment of the Memorial object 30 for preserving cremains device and methods 80 to produce memorial objects. In the drawings and illustrations, one notes well that the FIGS. 1-11 demonstrate the general configuration, use and method to produce this memorial product. The various examples of the objects are in the description herein and the methods provided in the below operations paragraphs.

The accompanying drawings, which are incorporated in and constitute a part of this specification, illustrate an embodiment of the Memorial object 30 for preserving cremains device and methods 80 to produce memorial objects that are preferred. The drawings together with the summary description given above and a detailed description given below serve to explain the principles of the Memorial object 30 for preserving cremains device and methods 80 to produce memorial objects. It is understood, however, that the Memorial object 30 for preserving cremains device and methods 80 to produce memorial objects are not limited to only the precise arrangements and instrumentalities shown. Other examples of cremains preservation objects and methods are still understood by one skilled in the art of cremains preservation to be within the scope and spirit shown here.

FIGS. 1 A through 1 D are sketches of the general memorial object for preserving cremains device and methods to produce. Shown in these views are: memorial objects 30 for preserving cremains; folded hands object 31; closed first object 32; process of immersing 40 object mold preparation; process of layering/surface mold preparation 60; and method of making memorial objects for preserving cremains 80. The memorial objects are for preserving cremains and made of a moldable material in a pre-determined shape of a person and/or an object, the moldable material being mixed in with an amount of cremains and permitted to cure into the pre-determined shape.

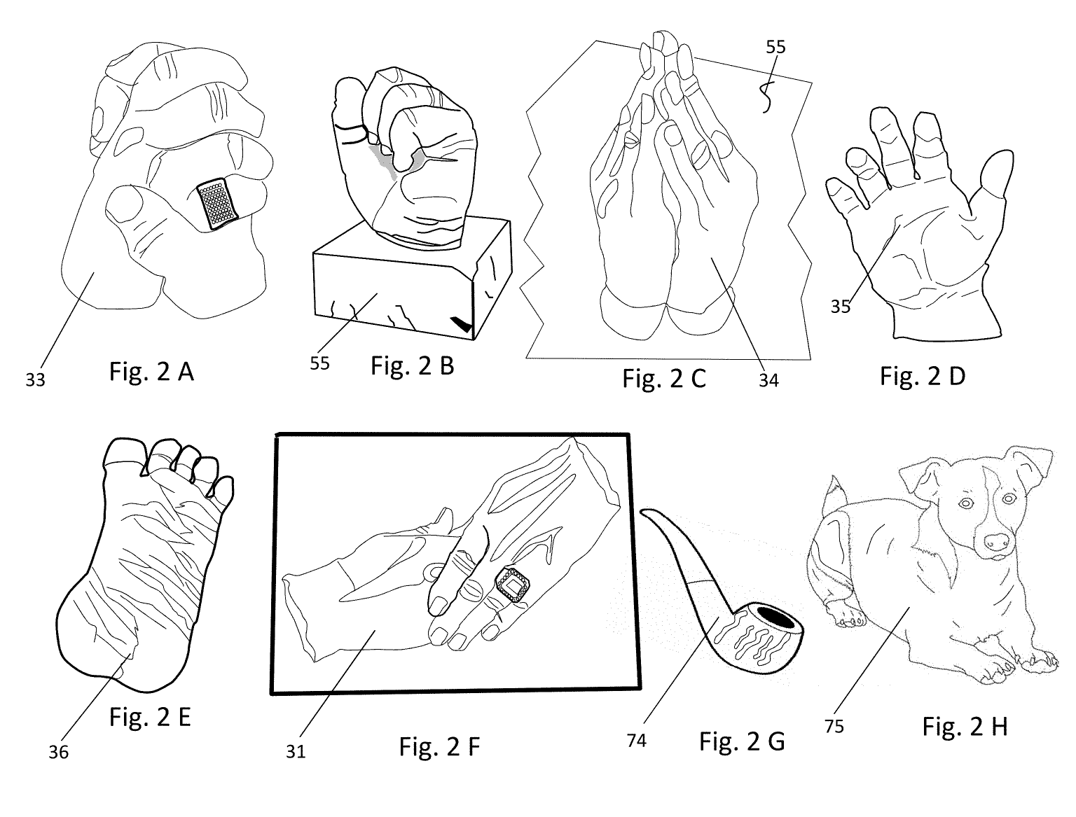

FIGS. 2 A through 2 H are sketches of the example memorial objects 30 made of the cremains and cementitious or plaster of Paris for preserving cremains. Demonstrated here are: folded hands object 31; closed first object 32; clenched hands 33; praying hands 34; open hand 35; foot 36; a base or frame 55 for object 30; a special pet 75—dog, cat, bird, paw or the like; and an object 74 such as a pipe, book, sports memorabilia, special jewelry and the like. These are all examples of objects and not an exhaustive list or limitation within the scope of this disclosure.

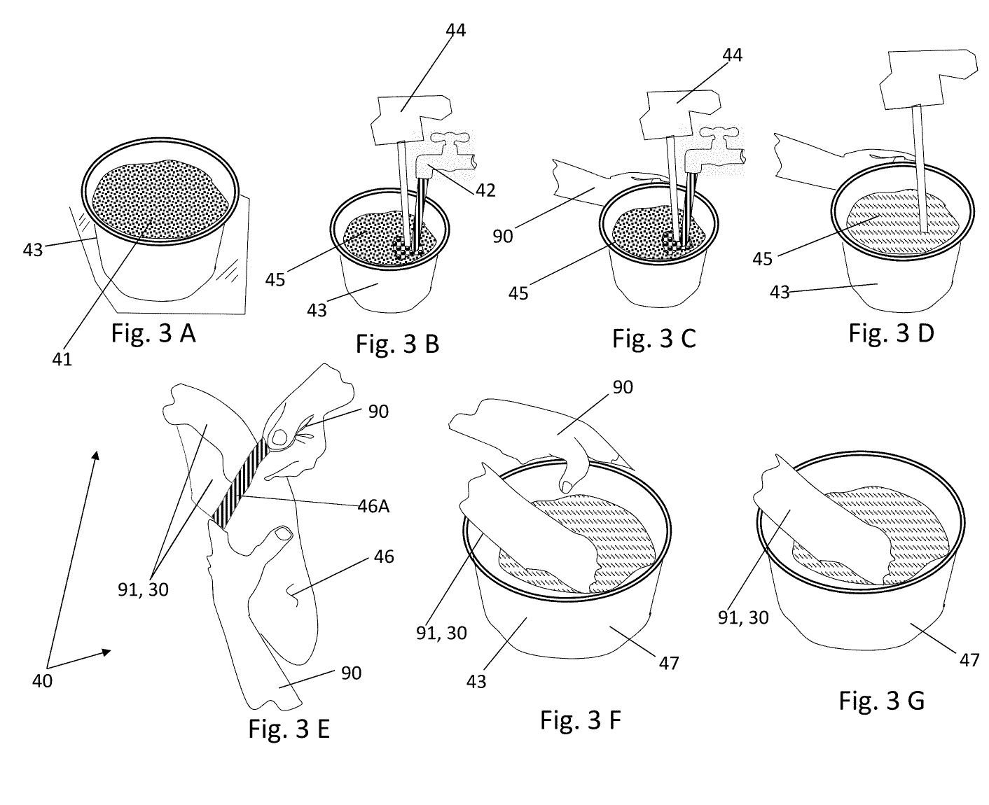

FIG. 3 A through 3 G are sketches of the mixing and preparation of the mold material. These sketches show: the process of immersing 40 object and mold preparation; dry mold materials 41 alginate, silicone or other humanly safe, fast setting, resilient, and penetrating to accurately portray details of the memorial object; adding liquid 42; mix container 43; a mixing device 44; mixed molding materials 45 (dry with liquid to make ready to pour and form); transfer material means 46; immersion vessel 47; operator 90; and person/object/pet or corpse 91. These views show mainly the gathering, preparation (add liquid and mix thoroughly to a thin and pourable consistency) of the molding material and then placing the molding material into a vessel for immersion. Then the immersion of a body part such as a hand or fist. The same preparation is used to prepare the molding material for the layering method shown in the below paragraphs.

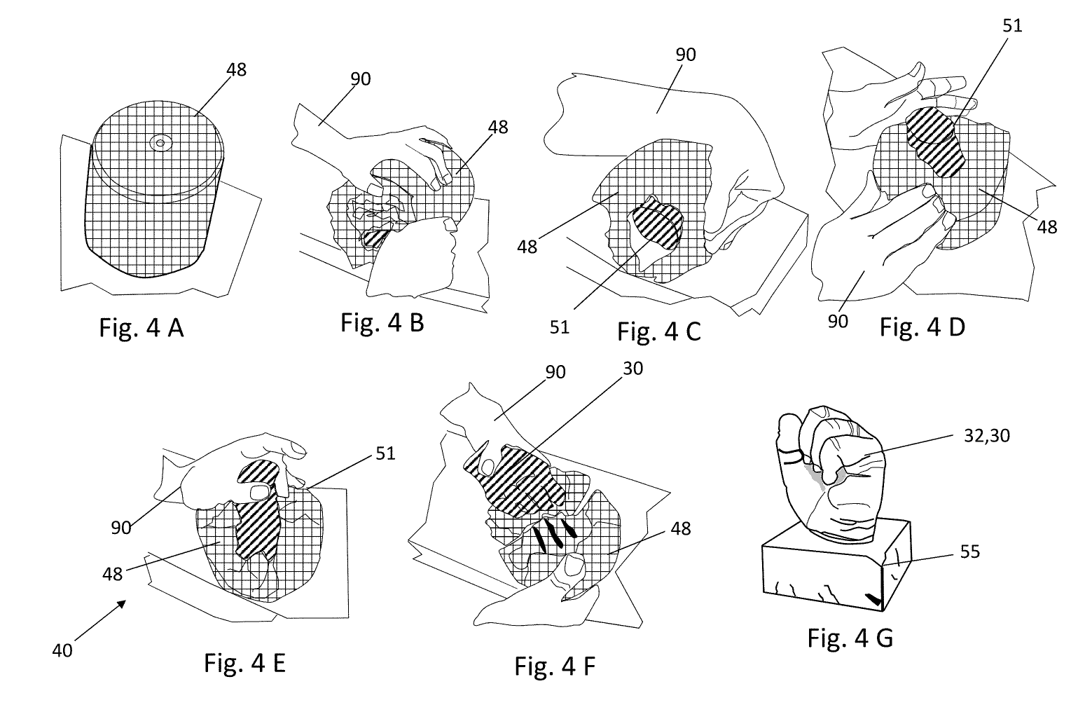

FIGS. 4 A through 4 G are sketches of the remaining steps for the immersion process to produce memorial objects for preserving cremains. Again are shown: memorial objects 30 for preserving cremains; closed first object 32; process of immersing 40 object mold preparation; mold 48 removed from vessel 47 and object 91; adding 49 cementitious material 50 such as cement, concrete, plaster of Paris or durable plastics, composite materials and other suitable materials for mixing cremains and ash into the parent material. Can be opaque, transparent, translucent or solid colors; set/gelled object 51; base or frame 55 for object 30; and the operator 90. In addition to body parts 92 the person or pet parts can be alive or dead. If alive, the mold makes a master replica that can be used when the person dies to mold the cremains of the deceased, the memorial objects 90 could be life sized or reduce-size replicas of animals, sporting objects, books and other memorable objects tied to the person whose cremains are being preserved. These views show the molded part in the vessel and then the removal of the molding material to reveal the memorial object.

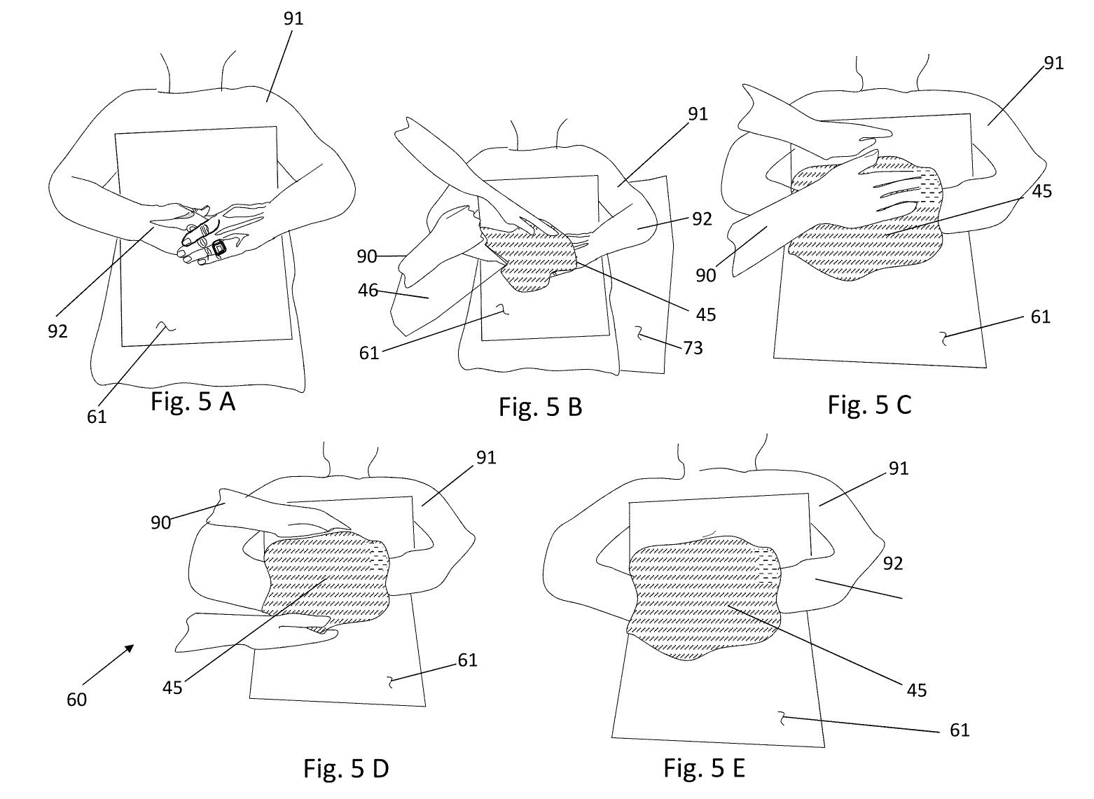

FIGS. 5 A through 5 E are sketches of the initial Steps for the larger process to produce memorial produce memorial objects for preserving cremains. In these views are shown and demonstrated: the mixing device 44; a process of layering/surface mold preparation 60; a cover 61 over object 91; the operator 90; the person/pet object or corpse 91; an alternate mold material requires coverage 62 and moisturizing and the specific body part 92 can be alive or dead. If alive, the mold makes a master replica that can be used when the person dies to mold the cremains of the deceased. These views show the preparation of the live or dead person, laying a protective sheet, positioning the part to be memorialized (here folded hands), and beginning to apply/layer the mold materials onto the object to be memorialized.

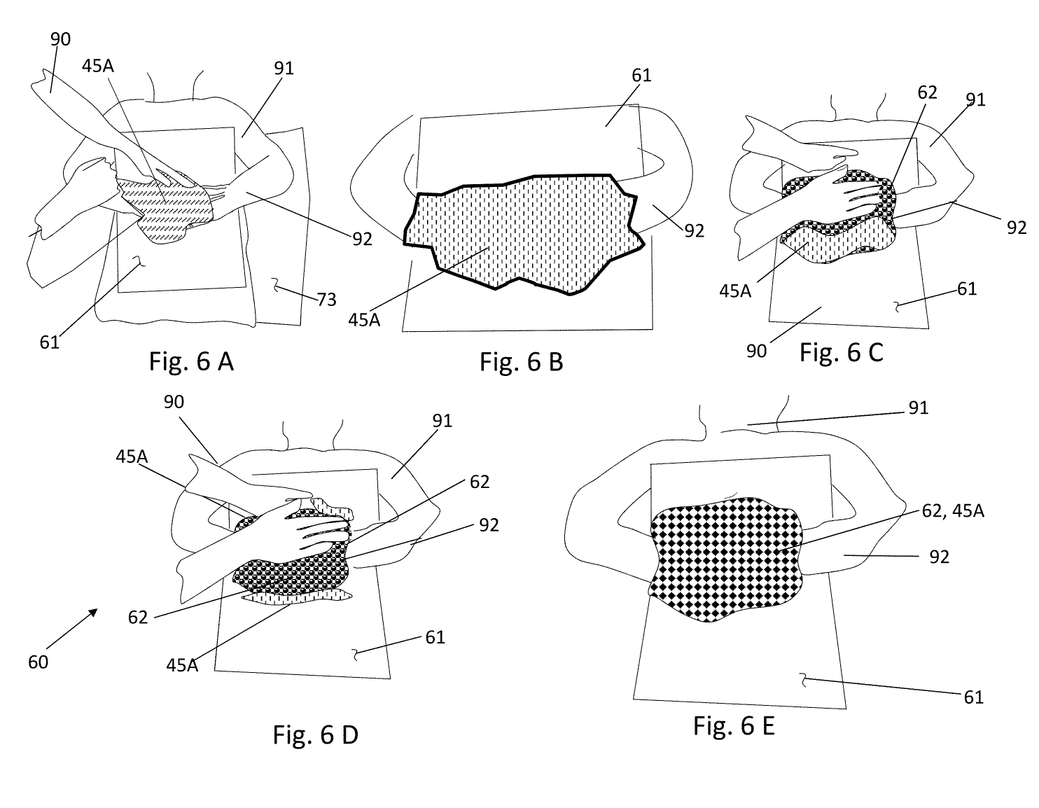

FIGS. 6 A through 6 E are sketches of additional steps in the larger process to produce memorial objects with cremains. Again these views show: the mixing device 44; a process of layering/surface mold preparation 60; a cover 61 over object 91; a cover fabric (such as gauze) or paper/sheet towels 62; an alternate mold material requires coverage 62 and moisturizing; an operator 90; the person or corpse 91; and the specific body part 92 can be alive or dead. If alive, the mold makes a master replica that can be used when the person dies to mold the cremains of the deceased. Additional layering is shown then wrapping with gauze, fabric or paper towels to retain moisture until gelled.

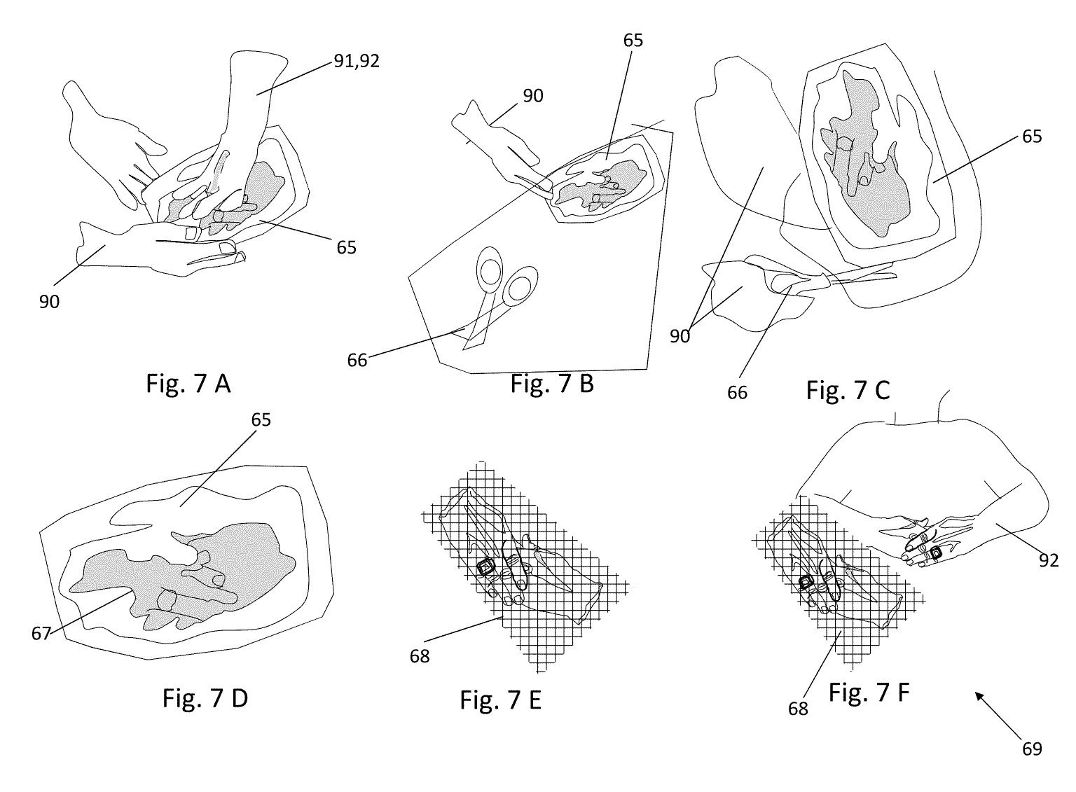

FIGS. 7 A through 7 F are sketches of the final steps to produce the mold from the larger process and to produce memorial objects with cremains. Finally are shown the sketches and elements: a set or gelled mold 65; a means 66 for trimming flash from gelled mold 65; a reverse mold cavity 67; the trimmed 68 reversed mold cavity 67; a comparison or quality audit step 69; the operator 90; the person or corpse 91; and the specific body part 92 can be alive or dead. If alive, the mold makes a master replica that can be used when the person dies to mold the cremains of the deceased. Here is shown the removal of the reverse cavity and preparation for molding the memorial object or a replica for later use after the live person has died and the cremains are available.

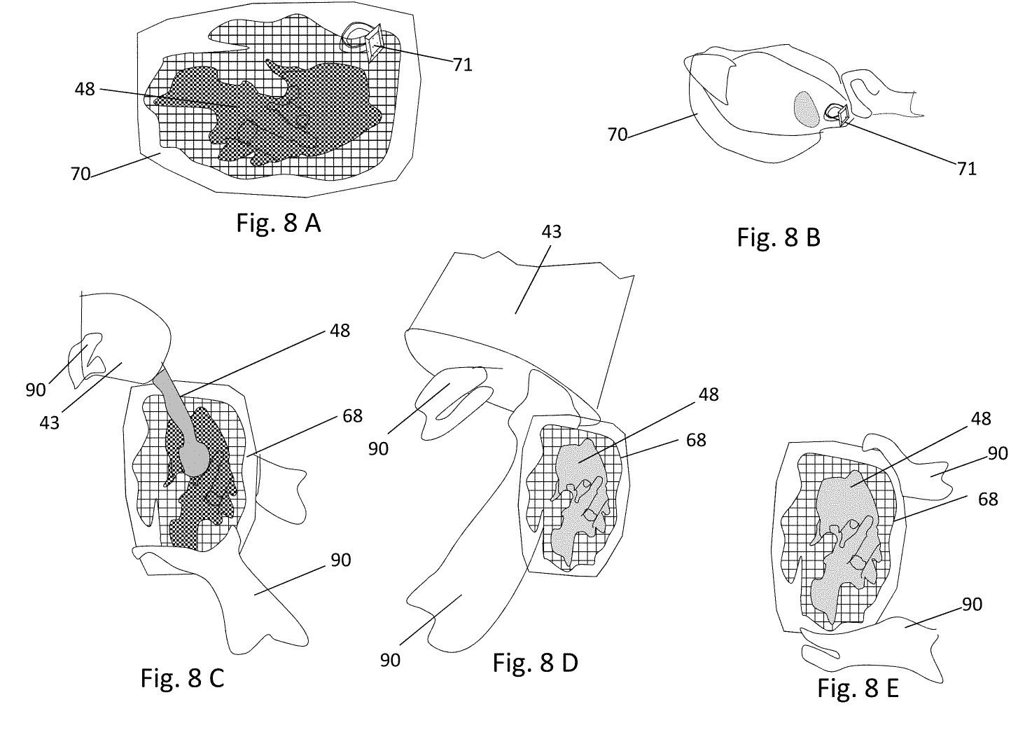

FIGS. 8 A and 8 B are sketches of adding jewelry to the mold and 8 C through 8 E show preserving the object or filling the mold. Here are demonstrated: the mix container 43; the mold 48 removed from vessel 47 and object 91; the trimmed 68 reversed mold cavity 67; optional plaster of Paris 70 or equal to add jewelry details 71; and an operator 90. These sketches and views show filling the reverse cavity with the memorial object or replica material such as cement, concrete, plaster of Paris or durable plastics, composite materials and other suitable materials for mixing cremains and ash into the parent material. This material can be opaque, transparent, translucent or solid colors.

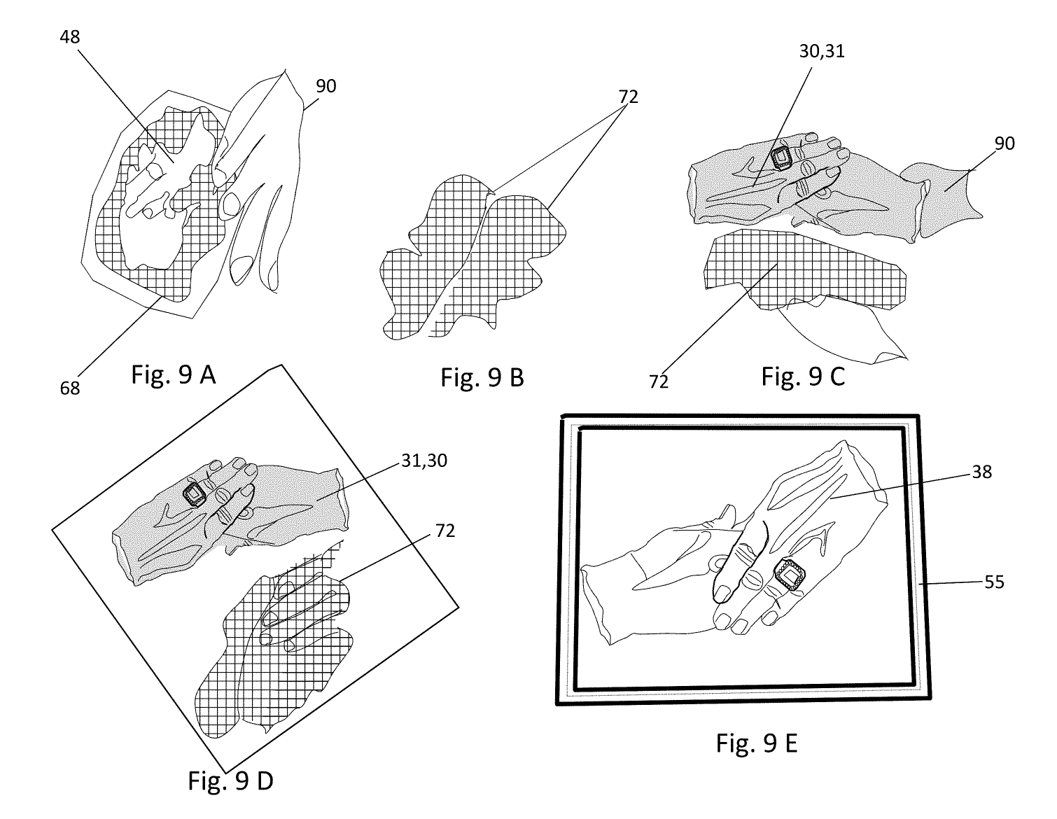

FIGS. 9 A through 9 E are sketches of removing the mold from the memorial object with cremains. These sketches show: the memorial objects 30 for preserving cremains; folded hands object 31; finished object 38 with surface finish—paint, clear coat (acrylic, varnish, shellac), metal leaf, powder coat, sealing, electro plating a metal—chrome, bronze alloy, zinc, copper, brass, tin or the like; the mold 48 removed from vessel 47 and object 91; a base or frame 55 for object 30; a trimmed 68 reversed mold cavity 67; the removed mold material 72; and the operator 90. Once the memorial object or replica is set, the molding material is removed, any desired surface finish is applied and the object may be mounted in a frame or on a base.

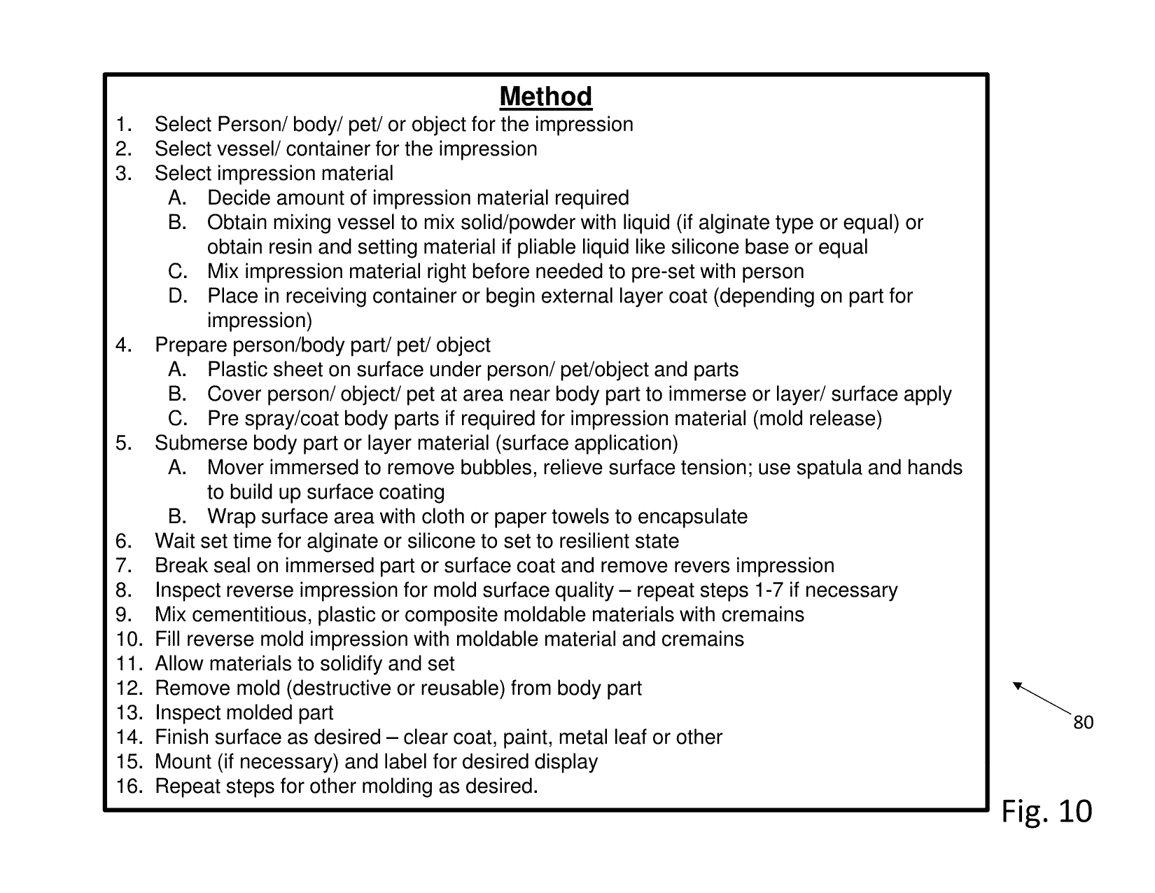

FIG. 10 is the specific process or method to produce the memorial object with cremains. This is explained in the below section on operations.

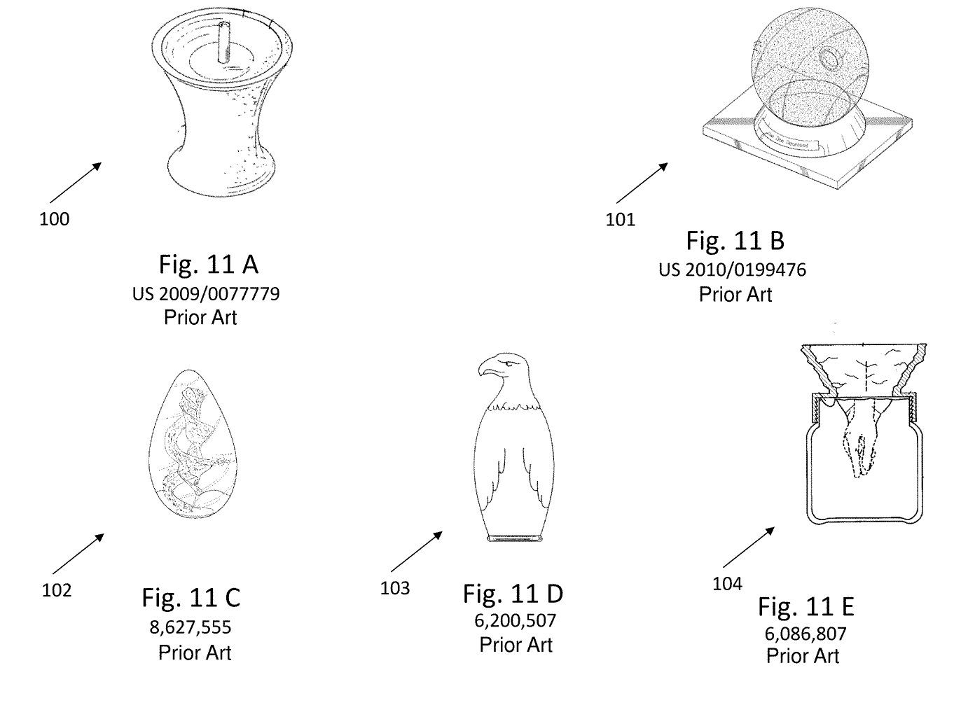

FIGS. 11 A through 11 E are sketches of prior art in memorial objects with cremains and molding processes. Here former patents and applications for various cremains methods and objects are shown. Prior Art 100 Patent Application US 2009/0077779 by Zimmerman; prior Art 101 Patent Application US 2010/0199476 by Cummings, et al.; prior Art 102 U.S. Pat. No. 8,627,555 by Kennedy; prior Art 103 U.S. Pat. No. 6,200,507 by Dennis; and prior Art 104 U.S. Pat. No. 6,086,807 by Wilson are shown. As can be seen, the Memorial object 30 for preserving cremains device and methods 80 to produce memorial objects are a unique product and method as described herein.

The details mentioned here are exemplary and not limiting. Other specific components and manners specific to describing the Memorial object 30 for preserving cremains device and methods 80 to produce memorial objects may be added as a person having ordinary skill in the field of the art of cremains preservation and methods thereof well appreciates.

### OPERATION OF THE PREFERRED EMBODIMENT

The Memorial object 30 for preserving cremains device and methods 80 to produce memorial objects have been described in the above embodiment. The manner of how the devices are made and the methodology developed are described below. Remember well that the memorial objects are for preserving cremains and made of a moldable material in a pre-determined shape of a person and/or an object, the moldable material being mixed in with an amount of cremains and permitted to cure into the pre-determined shape. One notes well that the description above and the operation described here must be taken together to fully illustrate the concept of the Memorial object 30 for preserving cremains device and methods 80 to produce memorial objects.

The methods 80 to produce memorial is shown in FIG. 10. It demonstrates: the preferred embodiment of a method to produce the Memorial object for preserving cremains comprising the following steps: (a) Selecting a body part of a person and/or an object for the impression; (b) Selecting a vessel/container for the impression; (c) Selecting a humanly safe, fast setting, resilient, and penetrating impression material; comes from group—(1) Deciding an amount of the impression material required alginate/silicone; (2) Obtaining a mixing vessel to mix solid/powder with liquid (if alginate type or equal) or obtain resin and setting material if pliable liquid like silicone base or equal; (3) Mixing impression material right before needed to pre-set with person to a homogeneous smooth mixture; and (4) Placing in receiving container or begin external layer coat (depending on part for impression);—(d) Preparing the person and/or object for the impression—(1) Plastic sheet on surface under person and parts; (2) Cover person at area near body part to immerse or layer/surface apply; and (3) Pre spray/coat body parts if required for impression material (mold release); (e) Coating Submersing the person and/or object layering from a surface the person and/or object art with the humanly safe, fast setting, resilient, and penetrating impression material—(1) Moving the immersed object of body part to remove bubbles, relieve surface tension; use spatula and hands to build up surface coating and (2) Wrapping a surface area with cloth or paper towels to encapsulate; (f) Waiting a set time for the impression material to set to a resilient state; (g) Breaking a seal on immersed part or surface coat and remove a reverse impression; (h) Inspecting the reverse impression for mold surface quality—repeating steps (a) to (g) if necessary for quality; (i) Mixing a cementitious, plastic or composite moldable materials with a cremains from a person; (j) Filling the reverse mold impression with the moldable material and the cremains; (k) Allowing the moldable material and the cremains to solidify and set; (l) Removing from the impression the memorial object of the body part of a person and/or an object; (m) Inspecting the memorial object; (n) Finishing a surface of the memorial object—clear coat, paint, metal leaf or other—(o) Mounting (if desired) and labeling for displaying; and (p) Repeating steps for other molding of memorial objects as desired. If desired, the body part 92 can be alive or dead. If alive, the mold makes a master replica that can be used when the person dies to mold the cremains of the deceased.

A further description of the making of a special impression device and processing this device as a memorial and as a vessel made from cremation ashes is now described. One molding material suitable for this process is alginate. The materials, for example and not as a limitation, can be alginate, silicone or other humanly safe, fast setting, resilient, and penetrating to accurately portray details of the memorial object Alginate is an impression material that is elastic and irreversible material which can be used to make the ceremonial vessel. The typical alginate impression material is used widely to take impressions in dental offices to take impression of the mouth. One can also take impressions of the nose, face, hands, and other body parts since alginate is friendly to the skin can be used safely even on babies. It is a powder substance that is mixed with water and makes a pudding-like gelatin mixture with a set time of one to four (1-4) minutes. Alginate by nature offers the good, resilient flexibility and duplicating properties to obtain an accurate impression. Sometimes alginate is referred to as an irreversible hydro colloid because when it is mixed a chemical reaction has occurred and it will not return to its original state of powder and water. The impressions obtained are accurate reproductions of the initial point of the model at hand. The material solidifies into an elastic mass capable of producing a negative reproduction of the model. Alginate impressions are taken in dental offices to be used a study models it is the most universally utilized impression material in dentistry. The process is not reversible or duplicable. Alginate is not reversible once it is mixed. It has a life span of thirty (30) to forty-five (45) minutes before it will begin to dehydrate and loose its accuracy as an impression material. It can be manipulated by wrapping it in a moist towel which can make it mobile for a matter of two to three (2-3) hours. Once it is dehydrated it will dry to the bone and shrink in mass up to 80 percent mass and become hardened. The remains, once dried, cannot be rehydrated. One must avoid interchanging the powder and water mix with various manufactures as it will vary the accuracy of the mix. Once the impression is made, the alginate will be completely destroyed when removing it from the model and will not be able to be duplicated. The use alginate cannot be reused at that point.

To make a duplication one can use the cast model and not need the original point of origin used to make the reverse impression or mold. One can also make a cast of the finished initial model and use it to make a second impression using the same processes that was used to make the initial cast. The alginate impression process, for best results and accuracy of the model should be poured within thirty to forty-five (30-45) minutes after the impression is obtained to minimize the air pockets and air bubbles that may adhere to the initial point of origin. One can relieve the surface tension by coating the device with the alginate prior to set time. Alginate impressions are used as study models in planning of dental lab procedures for making dentures crown because they are so accurate they can determine the minutest occlusions. Alginate impressions are used for educational study models due to their accuracy. The positive reproduction of the cast and can include anatomical and art portions.

The process includes: Select a vessel/container 47 for the impression cast based upon the size of the initial point of origin. The vessel must be slightly larger than the device due to not having the device compromised to touch the bottom or sides of the vessel. On then fluffs and/or aerates the alginate powder before dispensing it. Depending on the amount needed measure the alginate needed and put in a clean mixing bowl that is appropriate for the amount of alginate needed for the impression at hand. Next measure how much liquid/tap water is need to the amount of alginate needed referring to standard proprieties of alginate water ratios and depending on the temperature of the liquid—water or equal—that determine set times. Next one places the alginate in container first level off the alginate powder be careful to not pack the powder too tightly which will distort the appropriate alginate to water ratio and force water on top. Hand mixing can use a spatula or a wire whisk working fast to insure not to compromise the set time. It is even better to use an electric mixing device to speed up the mixing time so one has more time to work with the materials.

The mix should be a homogeneous smooth mixture that holds fast to the spatula. Collect alginate from the sides of the mixing bowl with spatula and transpose to the vessel that is capable of getting a correct proportioned impression. It is recommended to submerse the vessel into the prepared alginate to relieve any surface tension to abstain a more accurate impression that is free of air pockets or air bubbles. One can dip the object to be memorialized in and bring it all the way out than go back in for the final hold and set. Make sure that the device is not sitting on the bottom or touching the sides of the vessel or the impression will be distorted. After the alginate has set. Break the seal to release the surface tension suction to eliminate any tearing that can compromise the accuracy of the impression. Don't force the point of the original object from the set alginate before pulling it free from the gelled mix. Inspect the reverse impression in the alginate for any tearing or loose pieces of alginate material needs to be removed before pouring of the cementitious materials with the cremains or a plaster of Paris object for future use with cremains. Insure there are no voids. If the impression cannot be poured immediately it can at this point be wrapped in a moist paper towel to accelerate shelf life of the alginate from thirty to forty five (30-45) minutes to one to two (1-2) hours. The final restoration can only be as accurate and well adapted as the initial impression. The concrete or cementitious mix used for the purposes of making impressions and the ratio of water to cement and additives are suitable for this project.

The process shows the mix flows well into the pits, fissures and undercuts. It shows impeccable details. A heavy mix may produce air pockets in the undercuts, bends, and breaks of the impressions. A thin mix worked better and produced the best and more accurate cast due to a better flowabilty. The curing process takes 8 to 12 minutes and then removing the cast from the impression material takes 1 to 3 minutes. This process is a wat to keep loved ones close, the cremains of the loved ones are sealed and can be used as display. The impression can be take of anything personal or impressions of hands to suit the customer's personal inspirations. Provides a physical presence of the loved ones. A tangible way to hold on the loved ones. This is an alternative or cremation remains other than what is available to the customer. Jewelry and an urn.

As an alternative, one may desire using a silicone based material to make the impression rather than alginate. The silicone used for the purposes within this abstract for impression making and duplications are: for a two (2) part catalyst reaction. Materials; water, dish soap, silicone, bowl, glue gun, something or an object one want to make a mold of, scissors, knife, foam core, releasing agent, crystal clear, rubber bands, spatulas, sponges, air gun. Making a 2 part mold using a catalyst solution (silicon) One makes a custom mold form from foam core because it is easy to cut and break away. For an alternative three (3) part process: the clay body is the first step. Place the object that is to be replicated into the clay body within the custom made mold form. The clay is to be tight and form no pockets or gaps between the object and the clay process. Use a spatula, brushes or sponges to get a close to perfect seam one-half (½) way up the object to be cast. This process is only going to encase half of the object. As close to down the center as possible at ninety (90) degrees. The cleaner the parting or matching seam is to the model the better the impression. Registrations of the object are made into the clay so one can key the model to line-up and to eliminate the mold from shifting which helps to not make steps in the model. One uses an air gun to give a good edge and remove any water that could compromise the mold. Then cut the foam core to build the custom wall needed to surround the model. Then use a hot glue gun to secure the walls of the box the model is going to be contained and eliminate the silicone from running out of the sides. Seal the clay and the object with some (crystal clear) which is a medium to help pull the clay away from the silicone. A medium is used because silicone will only stick to silicone. The silicone is a clear solution and will be mixed in to parts, which is why it is defined as a catalyst solution. Before mixing the 2 parts of silicone a colorant can be added so that one can ensure an accurate mix. This helps to visualize that the mix is consistent. Remove any air bubbles by tapping the sides of the container the mix is in or by banging the mixing bowl on the work table to bounce any air pockets to the top. The silicone has a 6 minute window for one's working time. And a 30 minute set time. One must work with accuracy and speed. Pour the silicone into the custom made box that has the object sealed one-half (½) into the clay body over the top of the object to completely cover it. There are standard formulas for measuring how much silicone is needed for a specific job.

One must figure/calculate what the volume of the box is by inches. The volume per cubic inch of silicone is a constant number of essentially eighteen (18.5 or 18 to 19 plus or minus). Length multiplied times width multiplied times height multiplied times eighteen equals total grams of silicone divided by the two (2) parts. Mix each part—resin and catalyst—separately since it is a two part molding material and one only has an approximately six (6) minute working time before set. After the silicone has set after thirty (30) minutes remove the foam core and expose the one half clay and the one first half silicone. Place the silicone side down onto another piece of foam core cut to the specs that are needed. Remove the clay body and clean as well as possible. One can use sponges, water, and an air gun. Make sure no residue is present, dry the half mold section and the object that is encased in the silicone before moving to the third step of the process. Build the walls back as before with foam core and use the hot glue gun to secure the seams so that no silicone will leak from the sides in form. Use a spray release (crystal clear) to cover the silicone and the object because silicone will stick to silicone and we want to be able to break the two parts away from each other. Mix the second batch of silicone and pour it directly onto the already set silicone that has the object encased in it. Demold by removing the foam core wall exposing the two silicone bodies. Pull the two silicone parts away from each other. And remove the object that is to be duplicated. Know that one has a negative impression. Then rub the two silicone bodies down with some rubbing alcohol to remove any residue. Use a knife to open a channel to be able to pour the resin into the negative impression once it is put back together. Before putting the two silicone bodies back together using the registration lines spray down with a releasing agent. Use 2 pieces of foam core on top and bottom sides of the silicone and strap down with tape or rubber band to ensure that the model will not be mobile, to determine how much resin one needs to use. One can fill the impression with sand, water or rice to show how much volume one will need to fill. Mix the two part resin and add the cremated ashes. One can use up to approximately one third (⅓) of cremated ashes to the volume need of resin to be used. Start filling the impression with the resin and roll it around to release the surface tension and remove any air bubbles. The resin has an essentially six (6) minute work time and a thirty (30) minute set time. Remove the foam core and bands break away the two parts of the impression and expose the hardened resin. There will be some flashing due to the edges that came together to make the two part impression, they can be lightly sanded off or cut with a knife. Prime and paint to any color one wants. This mold can also be used to make any duplicates. Other materials that can be used to make impressions are: urethanes, epoxies and polyurethanes.

With this description it is to be understood that the Memorial object 30 for preserving cremains device and methods 80 to produce memorial objects is not to be limited to only the disclosed embodiment of these products and methods. The features of the Memorial object 30 for preserving cremains device and methods 80 to produce memorial objects are intended to cover various modifications and equivalent arrangements included within the spirit and scope of the description.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. A method to produce a memorial object for preserving cremains, the method is comprised of the following steps:
a) Selecting a body part of a person and/or an object for the impression;
b) Selecting a vessel/container for the impression;
c) Selecting a humanly safe, fast setting, resilient, and penetrating impression material;
d) Preparing the person and/or object for the impression;
e) Coating the person and/or object art with the humanly safe, fast setting, resilient, and penetrating impression material.
f) Waiting a set time for the impression material to set to a resilient state;
g) Breaking a seal on immersed part or surface coat and remove a reverse impression;
h) Inspecting the reverse impression for mold surface quality—repeating steps a) to g) if necessary for quality;
i) Mixing a moldable materials with a cremains from a person;
j) Filling the reverse mold impression with the moldable material and the cremains;
k) Allowing the moldable material and the cremains to solidify and set;
l) Removing from the impression the memorial object of the body part of a person and/or an object;
m) Inspecting the memorial object;
n) Finishing a surface of the memorial object;
o) Mounting (if desired) and labeling for displaying; and
p) Repeating steps for other molding of memorial objects as desired.

2. The method in claim 1 wherein the impression material is an alginate based molding material.

3. The method in claim 1 wherein the impression material is a silicon based molding material.

4. The method in claim 1 wherein the step selecting a humanly safe, fast setting, resilient, and penetrating impression material impression material is further comprising:
(1) Deciding an amount of the impression material required;
(2) Obtaining a mixing vessel to mix solid/powder with liquid (if alginate type or equal) or obtain resin and setting material if pliable liquid like silicone base or equal;
(3) Mixing the impression material right before needed to pre-set with person to a homogeneous smooth mixture; and
(4) Placing the mixed impression material in a receiving container.

5. The method in claim 1 wherein the step preparing the person and/or object for the impression is further comprising:
(1) Placing a plastic sheet on surface under person and parts;
(2) Covering a person at area near body part to immerse or layer/surface apply; and
(3) Pre spraying/coating body parts with a mold release.
(4)

6. The method in claim 1 wherein the step Coating the person and/or the object with the impression material is further comprising:
(1) Moving the immersed object of body part to remove bubbles, relieve surface tension; use spatula and hands to build up surface coating; and
(2) Wrapping a surface area with cloth or paper towels to encapsulate.

7. The method in claim 1 wherein the step Coating the person and/or the object with the impression material is an immersing of the person and/or the object into the impression material.

8. The method in claim 1 wherein the step Coating the person and/or the object with the impression material is a layering of the person and/or the object with the impression material.

9. The method in claim 1 wherein the moldable material for mixing with the cremains is selected from the group consisting of cement, concrete, plaster of Paris, durable plastic, and composite materials.

10. A memorial person and/or the object for preserving cremains comprised of: a moldable material in a pre-determined shape of a person and/or an object, the moldable material being mixed in with an amount of cremains and permitted to cure into the pre-determined shape.

11. The memorial person and/or the object in claim 10 wherein the pre-determined shape is selected from the group consisting of a pair of folded hands, a closed fist, a clenched hand, a pair of praying hands, an open hand, a pipe, a book, a pair of shoes, a sports memorabilia, a piece of sentimental jewelry, a dog, a cat, and a paw.

12. The memorial person and/or the object in claim 10 wherein the moldable material is selected from the group consisting of a cement, a concrete, a plaster of Paris, a durable plastic, and a composite material.

13. The material in claim 12 wherein the material is selected from a type that is an opaque, a transparent, a translucent and a solid colors.

14. The memorial person and/or the object permitted to cure into the pre-determined shape in claim 10 further comprised of a surface finish.

15. The memorial person and/or the object permitted to cure into the pre-determined shape and further comprised of a surface finish inn claim 14 wherein the surface finish is selected from the group consisting of a clear coat sealing, a paint, a metal leaf, and an electro plating metal.

16. The surface finish in claim 15 wherein the clear coat is selected from the group consisting of an acrylic plastic, a varnish, and a shellac.

17. The surface finish in claim 15 wherein the metal of the electro plating metal is selected from the group consisting of a chrome, a bronze alloy, a zinc, a copper, a brass, and a tin.

18. The memorial person and/or the object in claim 10 further comprised with a piece of jewelry.
